(19) United States
(12) Patent Application Publication
(10) Pub. No.: US 2025/0263954 A1
(43) Pub. Date: Aug. 21, 2025

(54) ELECTRONIC DOOR LOCK

(71) Applicant: Residential Elevators, Inc., Tallahassee, FL (US)

(72) Inventors: Jackson Jenkins, Tallahassee, FL (US); Thomas Hance, Cairo, GA (US)

(21) Appl. No.: 18/444,837

(22) Filed: Feb. 19, 2024

(51) Int. Cl. E05B 47/00

(52) U.S. Cl. CPC E05B 47/0046; E05B 2047/0017; E05B 2047/0067

(57) ABSTRACT

An electronic door lock assembly installed in a door jamb is designed to electronically move a latch assembly of a door latch or latch bolt out of the door jamb. The lock includes an exterior housing that houses an interior interlock housing, a strike actuator, at least two springs, a microprocessor, a plunger system, and a motor. When a signal is sent to the microprocessor and power is applied to the motor, the plunger translates within the interior interlock housing causing the strike actuator to extend such that the head member of the strike actuator pushes the latch out of the door jamb. Alternatively, when power is removed from the stepper motor, the electronic door assembly retracts the strike actuator, which allows the latch to rest within the door jamb.

### FIELD OF THE INVENTION

The present invention relates generally to electronic door locks, and more particularly, to a jamb-mounted electronic door lock assembly that fits behind a strike plate of a door jamb and is configured to actuate a striker to move a latch assembly bolt of a door latch or latch bolt out of the door jamb, allowing the door to be opened.

### SUMMARY OF THE INVENTION

The present invention is directed to an electronic door assembly. Introducing a first embodiment of the invention, the present invention consists of an electronic door lock assembly, comprising an outer housing that includes a proximal face member that is configured to receive a strike plate, at least one opening, and an internal space for receiving an interlock housing member. The interlock housing member includes a latch receiving space, and houses an actuator, one or more springs, a plunger, and a module. The module is coupled to the plunger on a distal end by a coupling device, such as a fastener, and the actuator is coupled to the plunger on a proximal end thereof via a pair of shoulder members that engage with exterior portions of the plunger. Activation of the module is configured to cause the plunger to translate within the interlock housing member to bias one or more springs coupled to the plunger and actuator and translate the actuator within the latch receiving space.

In one aspect, the outer housing is configured to fit behind a strike plate of a door jamb.

In another aspect, the module is a stepper motor that communicates with a microprocessor. The step motor may further include a driving member that is coupled to a coupling member that couples the driving member to the distal end of the plunger.

In another aspect, the electronic door lock assembly includes a biasing spring wrapped around a portion of the plunger. The electronic door lock assembly may further include a biasing spring disposed within an interior portion of the proximal end of the plunger and is in fluid communication with a portion of the actuator.

In another aspect, the latch receiving space is configurable to receive a portion of a door latch or latch bolt.

In another aspect, the module may communicate with an electronic device capable of monitoring whether the electronic door assembly is in a locked configuration or an unlocked configuration.

In another aspect, a power supply supplies power to the module. The power supply may include an AC adaptor, a DC adaptor, a mains adaptor, a RFID power source, a battery, a rechargeable battery, or combinations thereof.

In another exemplary embodiment, a method of moving a door latch out of a door jamb is introduced comprising the steps of: providing an electronic door lock comprising an exterior housing member housing an interior housing member, the interior housing member housing one or more springs, a plunger, a module coupled to a distal end of the plunger, an actuator coupled to the proximal end of the plunger, and a power supply powering the module; and sending an electrical signal to the module to activate the module and translate the plunger within the interior housing member biasing the one or more springs such that the actuator translates within the latch receiving space.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a perspective view of the electronic door lock assembly in accordance with an exemplary embodiment of the present invention;

FIG. 2 presents a partially-exploded view of the electronic door lock assembly;

FIG. 3 presents an exploded view of the electronic door lock assembly;

FIG. 4 presents a cross-sectional view of the electronic door lock assembly engaging a spring-loaded latch to provide an open-door configuration;

FIG. 5 presents a cross-sectional view of the door lock assembly engaging a spring-loaded latch to provide a locked-door configuration;

FIG. 6 presents a cross-sectional view of the door lock assembly engaging a spring-loaded latch to provide an unlocked-door configuration; and

FIG. 7 presents a cross-sectional view of the door lock assembly with the electronic switch of the assembly activated.

Like reference numerals refer to like parts throughout the several views of the drawings.

### DETAILED DESCRIPTION

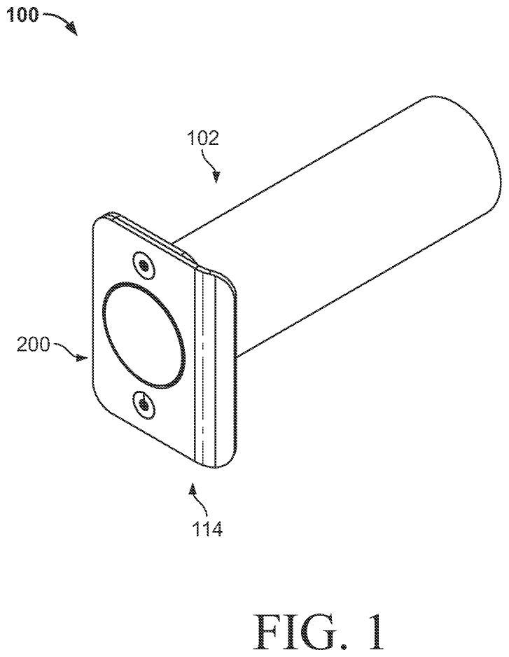

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

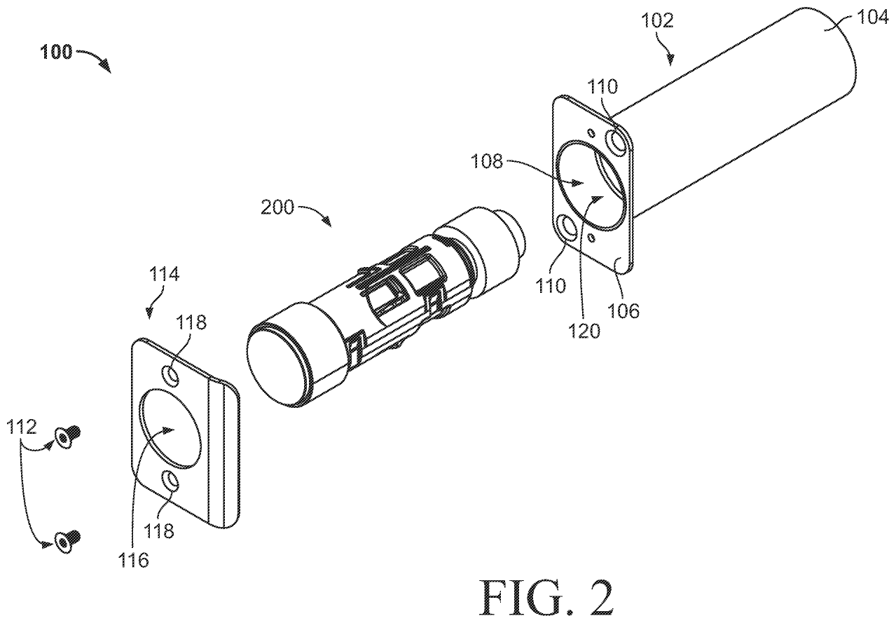

Referring initially to FIGS. 1 through 7, the present invention relates to a jamb-mounted electronic door lock assembly 100 (the “door lock assembly”) for moving the latch 300 of a latch assembly out of a door jamb to free the door from the jamb. Latch 300 includes but is not limited to a door latch, a deadbolt latch, or any type of sliding latch. The door lock assembly is designed to allow a locked door to be unlocked and freed with interference on the jamb side of the door. The door lock assembly 100 can be installed with minimal tooling, for example, a drill or a driver. This is an improvement over existing electronic locks that require drills, drivers, routers, chisels, and other tools to be installed successfully. With particular reference to FIGS. 1 and 2, the door lock assembly 100 generally comprises an exterior housing assembly 102 that houses an interlock mechanism 200. The exterior housing assembly 102 of the door lock assembly 100 comprises a housing body 104 that generally includes a unibody construction and has an opening 108 in the body 104. At the proximal end of the housing body 104, the exterior housing assembly 102 includes a face member 106 that includes one or more apertures 110 for receiving fasteners 112 that secures the exterior housing assembly 102 to at least one other component. In some exemplary embodiments, the body 104 of housing 102 is cylindrically shaped, and the face member 106 includes a substantially flat member that is rectangular shaped. The exterior housing assembly 102 includes a strike plate 114 with a central opening 116 and one or more aperture 118 for receiving fasteners 112 through. The strike plate 114 mates with the head member 106 of the body 104 of the exterior housing assembly 102, where the openings of both the head member 106 and the strike plate 114 are concentrically aligned. Disposable within the internal space 120 of the housing body 104 is the interlock mechanism 200.

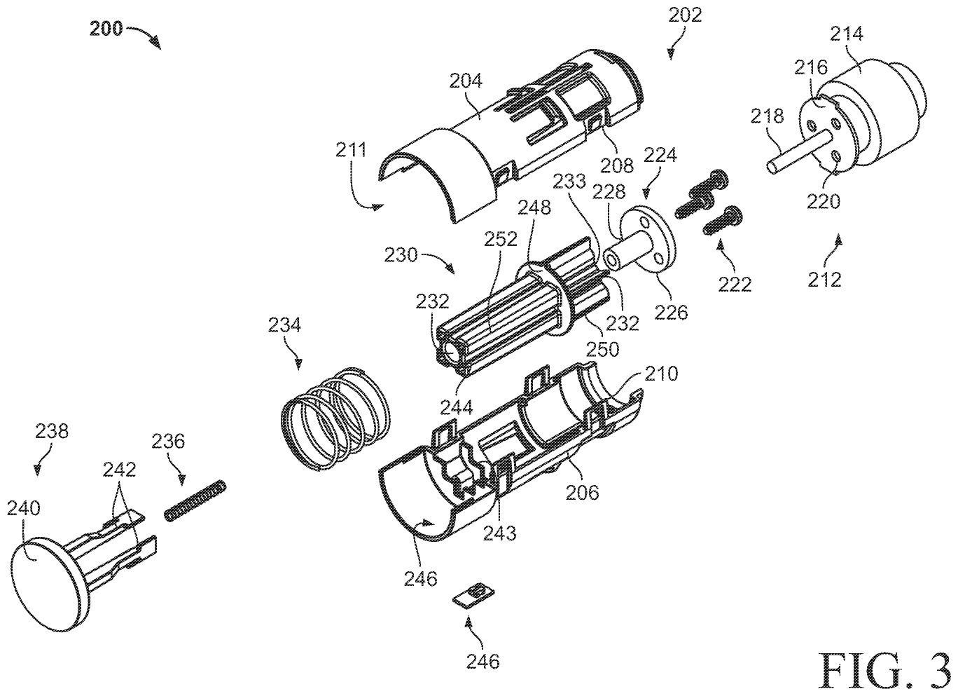

Turning now to FIGS. 2 and 3, the interlock mechanism 200 comprises an interlock housing 202 that is formed by least an upper housing member 204 and a lower housing member 206. The upper housing member 204 includes a male attachment member 208 disposed about a peripheral edge that engages a female attachment member 210 disposed about a peripheral edge of the lower housing member 206. Accordingly, the upper housing member 204 and the lower housing member 206 are detachable coupled to one another. When the upper housing member 204 and the lower housing member 206 are attached, both members form the interlock housing 202, which includes an internal space or cavity 211. Inside the interior space 211 of the interlock housing 202, the interlock mechanism includes and retains a strike actuator member assembly 238, one or more springs 234, 236, a plunger, a lead screw 224, and at least a portion of a stepper motor assembly 212. The housing members of the interlock mechanism in one exemplary embodiment comprise a polymer such as nylon 6/6 30% glass filled or equivalent material with a melting point of 497 Fahrenheit and an operating temperature of about 230 Fahrenheit.

The stepper motor assembly, 212 of the interlock mechanism 200, comprises a motor housing 214 that houses a motor, a mounting head 216, and a driving shaft member 218 connected to the motor. In one exemplary embodiment, the stepper motor assembly 212 comprises a stepper motor model Ding's Motion E25PD14J12-30ACM-001 or equivalent that has a power capacity of 3.85 W, 12V, 160 mA phase current and is capable of operating at a temperate range of −20 to 55 Celsius. The mounting head 216 of the stepper motor assembly 212 includes at least one aperture 220 for receiving a fastener 222. The fasteners in one exemplary embodiment comprise tamper-resistant screws. The distal end of the driving shaft member 218 is coupled to the lead screw 224 of the interlock mechanism 200. The lead screw includes a coupling face 226 that includes one or more apertures for receiving fasteners 222 and a lead screw shoulder member 228 designed and otherwise configured to engage with the plunger 230 of the interlock mechanism. The apertures of the lead screw 224 concentrically align with the apertures on the mounting head 216 of the stepper motor assembly 212 to allow removable coupling of the stepper motor assembly to the lead screw.

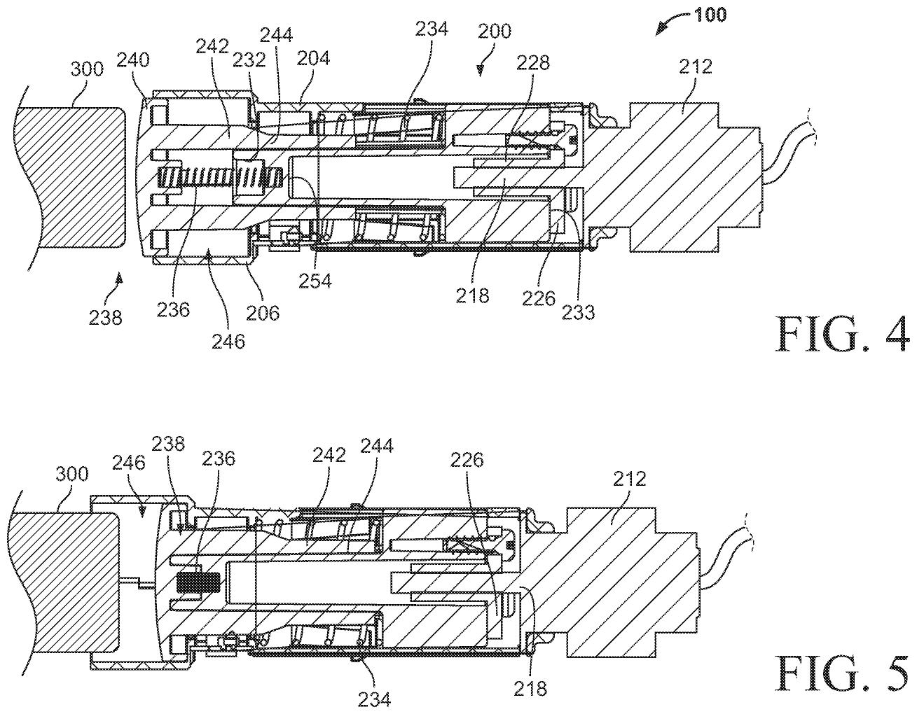

With continued reference to FIG. 3, the plunger 230 of the interlocking member comprises an elongated body that includes an external stopper 248, a pair of fins 250, and more than one upper surface 252 that create channels 244 on the exterior of the plunger 230 and further includes a proximal opening 232 and a distal opening 233 separated by an internal wall 254 (FIG. 4). The strike actuator 238 of the interlocking member 200 comprises a head member 240 that makes contact with a latch, and shoulder members 242 that extend outwardly from the head member 240 and engage the formed channels 244 on the plunger 230. Controlling the movement of stepper motor 212 is a microswitch PCB 246 that is removably coupled to a portion of either the upper housing 204 or lower housing 206 of the interlock housing 202. The microswitch 246 is electronically connected to the stepper motor and can communicate through a wire or wirelessly over a network with another electronic device (not shown).

As used herein, the term “electronic device” is capable of executing instructions. The term electronic device includes, but is not limited to, a personal computer, server computers, computing tablets, set-top boxes, video game systems, personal video recorders, telephones, cellular telephones, digital telephones, personal digital assistants (PDAs), portable computers, notebook computers, and laptop computers. Computing devices may run an operating system, including, for example, variations of the Linux, Unix, MS-DOS, Microsoft Windows, Palm OS, Symbian OS, and Apple Mac OS X operating systems. Computing devices also include communications software that allows for communication over the network. Depending on the electronic device or computing device, the communications software may provide support for communications using one or more of the following communications protocols or standards: the User Datagram Protocol (UDP), the Transmission Control Protocol (TCP), the Internet Protocol (IP), and the Hypertext Transport Protocol (HTTP); one or more lower-level communications standards or protocols such as, for example, the 10 and/or 40 Gigabit Ethernet standards, the Fiber Channel standards, one or more varieties of the IEEE 802 Ethernet standards, Asynchronous Transfer Mode (ATM), X.25. Integrated Services Digital Network (ISDN), token ring, frame relay, Point to Point Protocol (PPP), Fiber Distributed Data Interface (FDDI); and other protocols. Electronic devices may include a network interface card, network chip, or network chipset that allows for communication over the network. The electronic devices communicating with one another, in some exemplary embodiments, are interconnected to the Internet through many interfaces, including a network, such as a local area network (LAN) or a wide area network (WAN), dial-in-communications, cable modems, and special high-speed ISDN lines.

The term microprocessor, as used herein, refers to central processing units, processors, microcontrollers, reduced instruction set circuits (RISC), application-specific integrated circuits (ASIC), logic circuits, and any other circuit or processor capable of executing the functions described herein. As used herein, the terms “software” and “firmware” are interchangeable and include any computer program stored in memory for execution by the processor, including RAM memory, ROM memory, EPROM memory, EEPROM memory, and non-volatile RAM (NVRAM) memory. The above memory types are exemplary only and are thus not limiting as to the types of memory usable for storage of a computer program. In one exemplary embodiment, the microswitch 246 used to control the interlocking mechanism 200 is an E-Switch TD4700BW or equivalent that operates on a 5V, 1 mA current and has a life expectancy of 100,000 cycles and capable of operating in temperatures of −40 to 85 Celsius. The microprocessor and the stepper motor are powered by a power supply (not shown). The power supply includes an AC adaptor, a DC adaptor, a mains adaptor, a RFID power source, a battery, a rechargeable battery, or combinations thereof.

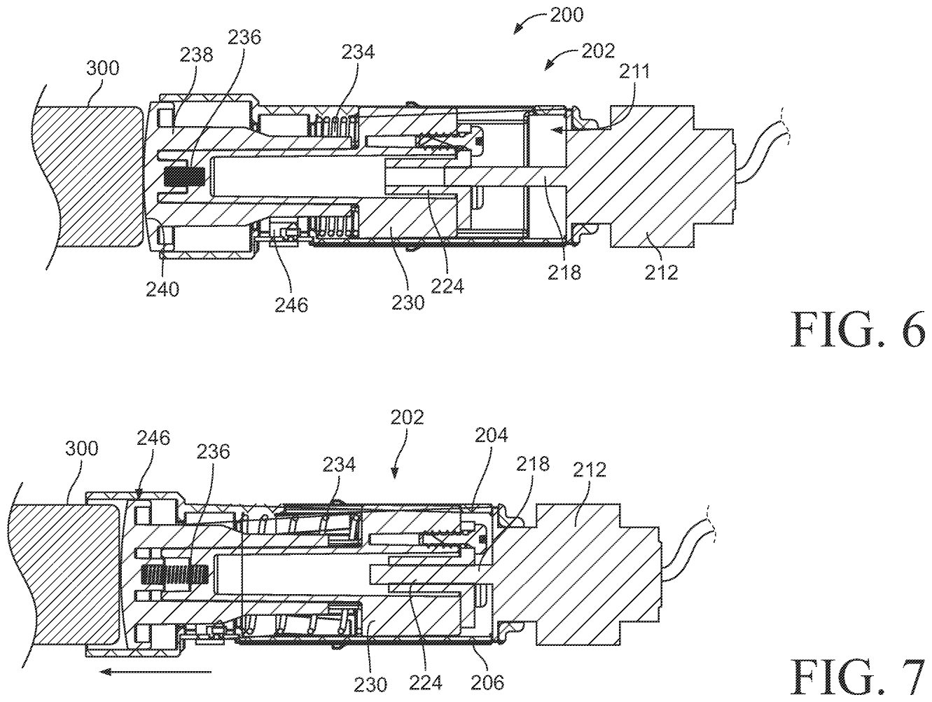

With reference now to FIGS. 4 through 7, the electronic assembly 100 functions to lock and unlock doors used outside residential elevator shafts. It is to be installed into the door frame and interacts with the spring-loaded latch 300 within the door to either lock or unlock the door (not shown). Referring to FIGS. 3 and 4 illustrate the electronic lock assembly 100 in an open-door configuration as the spring-loaded latch 300 does not contact the actuator 238. In this configuration, the stepper motor 212 receives a signal from an electronic device to maintain the stepper motor 212 idle, as springs 239 and 234 remain in an uncompressed configuration and spring 239 pushes against the actuator head 240 pushing it outwardly from the internal space 246 provided by the interlock housing 202. When the electronic lock assembly 100 is engaged, a signal from an electronic device is transmitted to the microprocessor 246 and the stepper motor 212. The signal can either be a signal to engage the stepper motor to provide a locked-door configuration (FIG. 5) or an unlocked configuration (FIG. 6). To provide a locked-door configuration, the signal transmitted to the microprocessor 246 prompts the microprocessor to send a command to the stepper motor 212 that is being supplied with an electrical current. The stepper motor 212 engages and rotates the driving member 218 engaging the lead screw 226. This rotational movement causes the plunger 230 to move within the interlock housing 202 which includes one or more surfaces 243 that engage the outer surfaces 252 of the plunger 230. This movement causes the actuator 238 to move inwardly, compressing spring 236 to create a void or space 246 within the interlock housing 202 for the latch 300 to enter and rest within space 246. While engaged, the motor of the electronic lock assembly 100 counteracts the spring's 236 tendency to push the latch outwardly (as seen in FIG. 7).

With reference now to FIGS. 3, 6, and 7, the electronic lock assembly 100 is configured to remotely unlock doors by engaging the spring-loaded latch 300 within a door. To do that, the electronic door lock assembly 100 is in communication with an electronic device (not shown) that is capable of communicating with the electronic device and sending the electronic device 100 a signal that engages the internal components of the electronic lock assembly 100. In one exemplary embodiment, a signal is sent from the electronic device to the microprocessor 246, and an electrical current is supplied to the stepper motor 212 via wires. The stepper motor 212 engages through the driving member 218, the lead screw 224 that is in communication with one side of the plunger 230 of the interlock mechanism 200. Movement of the plunger 230 causes the plunger 230 to translate within the internal space 211 of the interlock housing (i.e., away from the stepper motor and toward the opening by space 246), which causes the spring 234 wrapped about the exterior of the plunger 230 to push against a surface and compress. The head member 240 of the actuator 238 makes contact with the latch 300 and pushes the latch outwardly from the internal space 246 of the interlock mechanism 200 provided by the upper housing 204 and lower housing 206 of the interlock housing 202 (See FIG. 7). The actuator pushes the latch 300 until at least the head member 240 sits flush or is partially beyond the outermost peripheral edge of the interlock housing 202 (FIG. 6), causing the latch 300 to extend out of the internal space 246 of the interlock mechanism 200.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. An electronic door lock assembly, comprising:
an outer housing that includes a proximal face member, at least one opening, and an internal space;
an interlock housing member that includes a latch receiving space, the interlock housing member housing an actuator, a plunger, and a module;
wherein the module is coupled to the plunger on a distal end and the actuator is coupled to the plunger on a proximal end thereof, and
wherein activation of the module is configured to cause the plunger to translate within the interlock housing member to bias one or more springs coupled to the plunger and actuator and translate the actuator within the latch receiving space.

2. The electronic door lock assembly of claim 1, wherein the outer housing is configured to fit behind a strike plate of a door jamb.

3. The electronic door lock assembly of claim 1, wherein a strike plate is removably attachable to the proximal face member of the outer housing.

4. The electronic door lock assembly of claim 1, wherein the module is a stepper motor.

5. The electronic door lock assembly of claim 4, wherein the stepper motor includes a driving member that is coupled to a coupling member that couples the driving member to the distal end of the plunger.

6. The electronic door lock assembly of claim 1, wherein a biasing spring is wrapped around a portion of the plunger.

7. The electronic door lock assembly of claim 1, wherein a biasing spring is disposed within an interior portion of the proximal end of the plunger and is in fluid communication with a portion of the actuator.

8. The electronic door lock assembly of claim 1, wherein the latch receiving space is configured to receive a portion of a door latch or latch bolt.

9. The electronic door lock assembly of claim 1, wherein the module communicates with an electronic device capable of monitoring whether the electronic door assembly is in a locked configuration or an unlocked configuration.

10. The electronic door lock assembly of claim 1, wherein the module communicates with a microprocessor configured to execute one or more commands and transmit signals to the module.

11. The electronic door lock assembly of claim 1, wherein a power supply supplies power to the module.

12. The electronic door lock assembly of claim 11, wherein the power supply includes an AC adaptor, a DC adaptor, a mains adaptor, a RFID power source, a battery, a rechargeable battery, or combinations thereof.

13. An electronic door lock assembly, comprising:
an outer housing that includes a proximal face member, at least one opening, and an internal space;
an interlock housing member including an upper half removably attachable to a lower half, the interlock housing member including a latch receiving space and configured to house an actuator, one or more springs, a plunger, and a microprocessor in communication with a stepper motor; and
a power supply for powering the stepper motor;
wherein the stepper motor is coupled to the plunger on a distal end and the actuator is coupled to the plunger on a proximal end thereof, and
wherein activation of the stepper motor is configured to cause the plunger to translate within the interlock housing member to bias at least one of the springs coupled to the plunger or actuator and translate the actuator within the latch receiving space.

14. The electronic door lock assembly of claim 13, wherein the outer housing is configured to fit behind a strike plate of a door jamb.

15. The electronic door lock assembly of claim 13, wherein the stepper motor includes a driving member that is coupled to a coupling member that couples the driving member to the distal end of the plunger.

16. The electronic door lock assembly of claim 13, wherein a biasing spring is wrapped around a portion of the plunger.

17. The electronic door assembly of claim 13, wherein a biasing spring is disposed within an interior portion of the proximal end of the plunger and is in fluid communication with a portion of the actuator.

18. The electronic door assembly of claim 13, wherein the latch receiving space is configured to receive a portion of a door latch or latch bolt.

19. The electronic door assembly of claim 13, wherein the microprocessor and stepper motor communicate with an electronic device capable of monitoring whether the electronic door assembly is in a locked configuration or an unlocked configuration.

20. A method of moving a door latch out of a door jamb, comprising the steps of:
providing an electronic door lock comprising an exterior housing member housing an interior housing member, the interior housing member housing one or more springs, a plunger, a module coupled to a distal end of the plunger, an actuator coupled to the proximal end of the plunger, and a power supply powering the module; and
sending an electrical signal to the module to activate the module and translate the plunger within the interior housing member biasing the one or more springs such that the actuator translates within the latch receiving space.
